(19) United States
(12) Patent Application Publication
(10) Pub. No.: US 2022/0369197 A1
(43) Pub. Date: Nov. 17, 2022

(54) ENHANCED CALL CONTROL USING USER EQUIPMENT (UE)-TRIGGERED FALLBACK PROCEDURE

(71) Applicant: MEDIATEK INC., Hsinchu City (TW)

(72) Inventors: Rohit NAIK, Hsinchu City (TW); Shu-Lin YANG, Hsinchu City (TW); Hao-Chen CHOU, Hsinchu City (TW)

(21) Appl. No.: 17/719,703

(22) Filed: Apr. 13, 2022

Related U.S. Application Data
(60) Provisional application No. 63/187,448, filed on May 12, 2021.

(51) Int. Cl. H04W 36/36; H04W 36/14; H04W 36/30

(52) U.S. Cl. CPC H04W 36/36; H04W 36/14; H04W 36/30; H04L 65/1016

(57) ABSTRACT

A method for enhanced call control using User Equipment (UE)-triggered fallback procedure is provided. A UE starts a guard timer in response to initiating or receiving an Internet Protocol (IP) Multimedia Subsystem (IMS) call in a mobile communication network which utilizes a first Radio Access Technology (RAT). The UE determines whether a condition for call continuation in the mobile communication network is met when the guard timer expires. The UE triggers a fallback from the first RAT to a second RAT in response to the condition for call continuation in the mobile communication network not being met.

### CROSS REFERENCE TO RELATED APPLICATIONS

This application claims priority under 35 U.S.C. § 119 from U.S. Provisional Application No. 63/187,448, entitled “Method for UE to self-trigger EPS fallback or RAT fallback based on EPS-FB or QOS establishment guard timer”, filed on May 12, 2021, the subject matter of which is incorporated herein by reference.

### BACKGROUND OF THE APPLICATION

### Field of the Application

The application generally relates to call handling, and more particularly, to enhanced call control using User Equipment (UE)-triggered fallback procedure.

### Description of the Related Art

In a typical mobile communication environment, a User Equipment (UE) (also called a Mobile Station (MS)), such as a mobile telephone (also known as a cellular or cell phone) or a tablet Personal Computer (PC) with wireless communication capability, may communicate voice and/or data signals with one or more cellular networks. The wireless communication between the UE and the cellular networks may be performed using various Radio Access Technologies (RATs), such as Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA-2000) technology, Time Division-Synchronous Code Division Multiple Access (TD-SCDMA) technology, Worldwide Interoperability for Microwave Access (WiMAX) technology, Long Term Evolution (LTE) technology, LTE-Advanced (LTE-A) technology, etc. In particular, GSM/GPRS/EDGE technology is also called 2G technology; WCDMA/CDMA-2000/TD-SCDMA technology is also called 3G technology; and LTE/LTE-A/TD-LTE technology is also called 4G technology.

These RAT technologies have been adopted for use in various telecommunication standards to provide a common protocol that enables different wireless devices to communicate on a municipal, national, regional, and even global level. An example of an emerging telecommunication standard is the 5G New Radio (NR). The 5G NR is a set of enhancements to the LTE mobile standard promulgated by the Third Generation Partnership Project (3GPP). It is designed to better support mobile broadband Internet access by improving spectral efficiency, reducing costs, and improving services.

During establishment of an IP Multimedia Subsystem (IMS) call, a 5G network may trigger the Evolved Packet System (EPS) fallback or Radio Access Technology (RAT) fallback if it does not support the Quality of Service (QoS) for Voice over NR (VoNR), or if it determines that the condition for successfully establishing a VoNR call cannot be met. According to the 3GPP specifications in compliance with 5G technology, the UE may follow through with the fallback procedure to move the call from the 5G network to a 4G network only when triggered by the 5G network. However, it has been observed that, in a real network environment, the UE may fail to receive the network trigger command for EPS fallback or RAT fallback, or the network trigger command may be delayed, or the network may fail to establish QoS for the call. In such situations, the UE will keep waiting for the network trigger command and the VoNR call may be delayed or may even fail. This may critically impact user experience.

A solution is sought.

### BRIEF SUMMARY OF THE APPLICATION

In one aspect of the application, a method executed by a User Equipment (UE) is provided. The method comprises the following steps: starting a guard timer in response to initiating or receiving an Internet Protocol (IP) Multimedia Subsystem (IMS) call in a mobile communication network which utilizes a first Radio Access Technology (RAT); determining whether a condition for call continuation in the mobile communication network is met when the guard timer expires; and triggering a fallback from the first RAT to a second RAT in response to the condition for call continuation in the mobile communication network not being met.

In another aspect of the application, a UE comprising a wireless transceiver and a controller is provided. The wireless transceiver which, during operation, performs wireless transmission and reception using a first RAT or a second RAT. The controller is communicatively coupled to the wireless transceiver such that, during operation, the controller performs operations comprising: starting a guard timer in response to initiating or receiving, via the wireless transceiver, an IMS call in a mobile communication network which utilizes the first RAT; determining whether a condition for call continuation in the mobile communication network is met when the guard timer expires; and triggering a fallback from the first RAT to the second RAT via the wireless transceiver in response to the condition for call continuation in the mobile communication network not being met.

In one example, the UE receives Quality of Service (QoS) configuration for the IMS call from the mobile communication network before the guard timer expires, and stops the guard timer and triggers the fallback from the first RAT to the second RAT in response to the QoS configuration indicating insufficient resources for call continuation in the mobile communication network.

In one example, the value of the guard timer is configured by the mobile communication network, or the UE applies a default value for the guard timer (when the mobile communication network does not configure the value of the guard timer). The value of the guard timer may be configured by the mobile communication network using a HyperText Transfer Protocol (HTTP), Short Message Service (SMS), or Session Initiation Protocol (SIP). Alternatively, the value of the guard timer may be configured in an IMS Management Object (MO) received from the mobile communication network.

In one example, the first UE sends a second SIP 200 OK message to the second UE in response to the second SIP INVITE message, wherein the second SIP 200 OK message indicates that the first UE is allowed to only send media data to the second UE (rather than receive media data from the second UE). The second SIP 200 OK message comprises an SDP attribute “a=sendonly” indicating that the first UE is allowed to only send media data to the second UE (rather than receive media data from the second UE). The IMS MO may comprise a node for the guard timer, which specifies the following: the value of the guard timer; and a timeout action indicator which instructs the UE to trigger the fallback from the first RAT to the second RAT, or to disconnect the call over the first RAT and redial the call over the second RAT, or to maintain the call over the first RAT, when the guard timer expires.

In one example, the condition for call continuation in the mobile communication network comprises at least one of: QoS configuration is allocated by the mobile communication network; a signal-strength indicator associated with the mobile communication network is greater than a first threshold; and a user-experience indicator is lower than a second threshold. The signal-strength indicator may be a Received Signal Strength Indicator (RSSI), a Packet Error Rate (PER), a Bit Error Rate (BER), a Signal-to-Noise Ratio (SNR), or an Interference-to-Signal Ratio (ISR), and the user-experience indicator may be a jitter buffer delay, a round trip delay, or a packet loss rate.

In one example, the guard timer is started when sending or receiving an INVITE message during a SIP session using a Transmission Control Protocol (TCP), or when receiving a 100 trying message during a SIP session using a User Datagram Protocol (UDP).

In one example, the fallback from the first RAT to the second RAT is an Evolved Packet System (EPS) FallBack (FB) in response to the condition for call continuation in the mobile communication network not being met before a SIP session for establishing the IMS call is completed, or the fallback from the first RAT to the second RAT is a RAT FB in response to the condition for call continuation in the mobile communication network not being met after the SIP session for establishing the IMS call is completed.

Other aspects and features of the present application will become apparent to those with ordinary skill in the art upon review of the following descriptions of specific embodiments of the apparatuses and methods for enhanced call control using UE-triggered fallback procedure.

### BRIEF DESCRIPTION OF DRAWINGS

The application can be more fully understood by reading the subsequent detailed description and examples with references made to the accompanying drawings, wherein:

FIG. 1 is a block diagram of a mobile communication environment according to an embodiment of the application;

FIG. 2 is a block diagram illustrating a UE according to an embodiment of the application;

FIG. 3 is a schematic diagram illustrating an example of the guard timer being configurable by network using HyperText Transfer Protocol (HTTP);

FIG. 4 is a schematic diagram illustrating an example of the guard timer being configurable by network using Short Message Service (SMS);

FIG. 5 is a schematic diagram illustrating an example of the guard timer being configurable by network using Session Initiation Protocol (SIP);

FIG. 6 is a message sequence chart illustrating the enhanced call control using UE-triggered fallback procedure according to an embodiment of the application;

FIG. 7 is a message sequence chart illustrating the enhanced call control using UE-triggered fallback procedure according to another embodiment of the application;

FIG. 8 is a message sequence chart illustrating a Mobile Originated (MO) case of enhanced call control using UE-triggered fallback procedure according to an embodiment of the application;

FIG. 9 is a message sequence chart illustrating a Mobile Terminated (MT) case of enhanced call control using UE-triggered fallback procedure according to an embodiment of the application; and

FIG. 10 is a flow chart illustrating the method for enhanced call control using UE-triggered fallback procedure according to an embodiment of the application.

### DETAILED DESCRIPTION OF THE APPLICATION

The following description is made for the purpose of illustrating the general principles of the application and should not be taken in a limiting sense. It should be understood that the embodiments may be realized in software, hardware, firmware, or any combination thereof. The terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

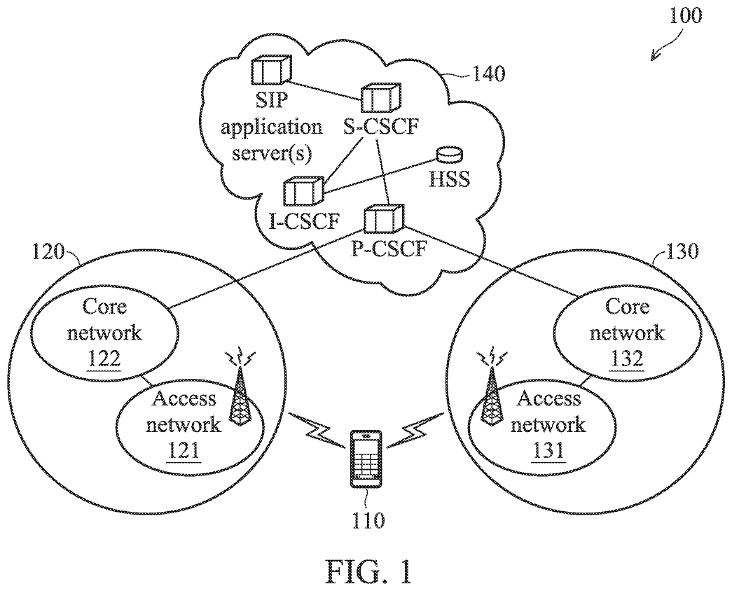

FIG. 1 is a block diagram of a mobile communication environment according to an embodiment of the application.

As shown in FIG. 1, the mobile communication environment 100 includes a UE 110, two mobile communication networks 120 and 130, and an IMS network 140.

The UE 110 may be a feature phone, a smartphone, a panel Personal Computer (PC), a laptop computer, a Machine Type Communication (MTC) device, or any mobile communication device supporting the RATs utilized by the mobile communication networks 120 and 130. The UE 110 may connect to one or both of the mobile communication networks 120 and 130 to obtain mobile services (e.g., voice and/or data services).

The mobile communication network 120 may be a cellular network including an access network 121 and a core network 122, while the mobile communication network 130 may be a cellular network including an access network 131 and a core network 132. Each of the access networks 121 and 131 is responsible for processing radio signals, terminating radio protocols, and connecting the UE 110 with the core network 122/132, while each of the core networks 122 and 132 is responsible for performing mobility management, network-side authentication, and interfaces with public/external networks (e.g., the IMS network 140 and/or the Internet).

Specifically, the RAT utilized by the mobile communication network 120 is more advanced than the RAT utilized by the mobile communication network 130. For example, the mobile communication network 120 may be a 5G network, while the mobile communication network 130 may be a 4G network.

If the mobile communication network 120 is a 5G network (e.g., an NR network), the access network 121 may be a Next Generation Radio Access Network (NG-RAN) and the core network 122 may be a Next Generation Core Network (NG-CN) (or called 5G Core (5GC)). The NG-RAN may include one or more gNBs. Each gNB may further include one or more Transmission Reception Points (TRPs), and each gNB or TRP may be referred to as a 5G cellular station. Some gNB functions may be distributed across different TRPs, while others may be centralized, leaving the flexibility and scope of specific deployments to fulfill the requirements for specific cases. The NG-CN may support various network functions, including an Access and Mobility Management Function (AMF), a Session Management Function (SMF), a User Plane Function (UPF), a Policy Control Function (PCF), an Application Function (AF), an Authentication Server Function (AUSF), and a Non-3GPP Inter-Working Function (N3IWF), wherein each network function may be implemented as a network element on dedicated hardware, or as a software instance running on dedicated hardware, or as a virtualized function instantiated on an appropriate platform, e.g., a cloud infrastructure.

If the mobile communication network 130 is a 4G network (e.g., an LTE/LTE-A/TD-LTE network), the access network 131 may be an Evolved-Universal Terrestrial Radio Access Network (E-UTRAN) and the core network 132 may be an Evolved Packet Core (EPC). The E-UTRAN may include at least an evolved NodeB (eNB) (e.g., a macro eNB, femto eNB, or pico eNB). The EPC may include a Home Subscriber Server (HSS), Mobility Management Entity (MME), Serving Gateway (S-GW), and Packet Data Network Gateway (PDN-GW or P-GW).

The IMS network 140 is a call service system consisting of various network functions for providing Internet Protocol (IP) multimedia services to the UE 110 over the mobile communication network 120/130. For example, the IMS network 140 may include an IMS core which at least includes a Home Subscriber Server (HSS), a Call Session Control Function (CSCF), a Signaling Gateway (SGW), a Media Gateway Control Function (MGCF), and a Media Resource Function (MRF), wherein each network function may be implemented as a network element on dedicated hardware (e.g., a computing device, a server, or a processing circuit of a processor in a computing device or server), or as a software instance running on dedicated hardware, or as a virtualized function instantiated on an appropriate platform, e.g., a cloud infrastructure. The HSS generally refers to the master database that maintains all user profile information used to authenticate and authorize subscribers. The CSCF is the heart of the IMS architecture, which is responsible for controlling sessions between endpoints (referred to as terminals in the IMS specifications) and applications. The CSCF function is distributed across three types of functional elements, including Proxy CSCF (P-CSCF), Interrogating CSCF (I-CSCF), and Serving CSCF (S-CSCF), based on the specialized function they perform. The SGW and the MGCF are responsible for providing interoperability with the Public Switched Telephone Network (PSTN). The MRF provides media-related functions such as the playing of tones and digital announcements.

The IP multimedia services provided by the IMS network 140 at least includes call services, such as Voice over LTE (VoLTE), Video over LTE (ViLTE), Voice over NR (VoNR), and/or Video over NR (ViNR), etc. In addition, the IP multimedia services may also include data services, such as Short Message Service (SMS) over IMS, Mission Critical Push To Talk (MCPTT), Mission Critical Video (MCVideo), Mission Critical Data (MCData), Rich Communication Services (RCS), XML Configuration Access Protocol (XCAP), and others.

In accordance with one novel aspect, a guard timer (e.g., called “EPS-FB/RAT-FB wait timer” or “QoS establishment wait timer”) is newly introduced to the UE 110, which allows the UE 110 to self-trigger the EPS fallback or RAT fallback when the condition for call continuation in the currently registered network (e.g., a 5G network) is not met. To be more specific, the guard timer is started when the UE 110 initiates or receives an IMS call in the currently registered network, and upon expiry of the guard timer, the UE 110 determines whether the condition for call continuation in the currently registered network is met. If the determination result is negative (i.e., the condition for call continuation in the currently registered network is not met), the UE 110 takes the initiative in triggering the fallback from 5G to 4G (i.e., EPS fallback or RAT fallback) to establish the call.

The EPS fallback and RAT fallback are two deployment scenarios that support redirection/handover to E-UTRAN during the call setup phase.

[EPS fallback] The UE camps on 5G NR to obtain data service and falls back to LTE to obtain voice service. After the UE makes a voice call, NR instructs the UE to access LTE by triggering a handover or redirection procedure. Then IMS provides VoLTE service for the UE. This option is applicable with the early phase of 5G deployment where NR is deployed with 5GC for hotspot coverage. It can avoid voice interruption due to frequent handovers and guaranteeing user experience.

[RAT fallback] The UE camps on 5G NR to obtain data service and falls back to eLTE to obtain voice service. When the UE makes a voice call, NR instructs the UE to access eLTE by triggering a handover or redirection procedure. Then IMS provides VoLTE service for the UE. After the voice session is terminated, the UE may move back to 5G. This solution requires the existing LTE to be upgraded to eLTE, i.e., eNodeB should support N1/N2/N3 interface. In addition, eLTE and NR should be deployed together, which has a higher requirement for existing network upgrade.

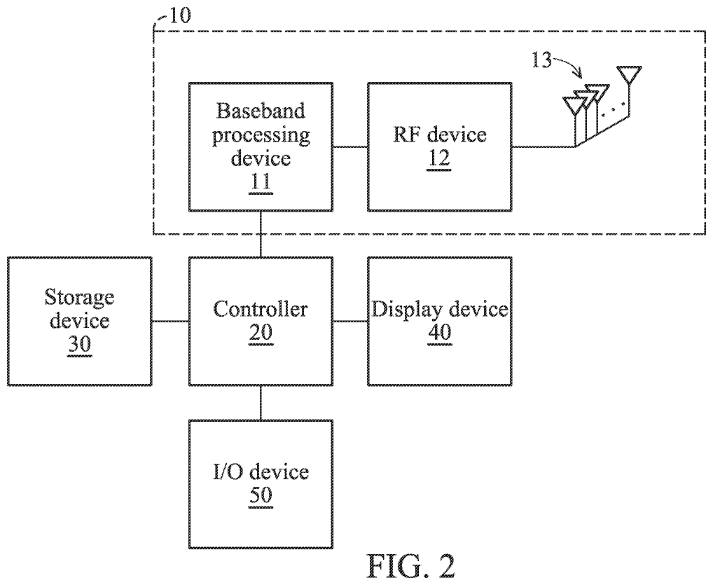

FIG. 2 is a block diagram illustrating a UE according to an embodiment of the application.

As shown in FIG. 2, a UE (e.g., the UE 110) may include a wireless transceiver 10, a controller 20, a storage device 30, a display device 40, and an Input/Output (I/O) device 50.

The wireless transceiver 10 is configured to perform wireless transmission and reception to and from one or both of the mobile communication networks 120 and 130.

Specifically, the wireless transceiver 10 may include a baseband processing device 11, a Radio Frequency (RF) device 12, and antenna 13, wherein the antenna 13 may include an antenna array for beamforming.

The baseband processing device 11 is configured to perform baseband signal processing and control the communications between subscriber identity card(s) (not shown) and the RF device 12. The baseband processing device 11 may contain multiple hardware components to perform the baseband signal processing, including Analog-to-Digital Conversion (ADC)/Digital-to-Analog Conversion (DAC), gain adjusting, modulation/demodulation, encoding/decoding, and so on.

The RF device 12 may receive RF wireless signals via the antenna 13, convert the received RF wireless signals to baseband signals, which are processed by the baseband processing device 11, or receive baseband signals from the baseband processing device 11 and convert the received baseband signals to RF wireless signals, which are later transmitted via the antenna 13. The RF device 12 may also contain multiple hardware devices to perform radio frequency conversion. For example, the RF device 12 may include a mixer to multiply the baseband signals with a carrier oscillated in the radio frequency of the supported RATs, wherein the radio frequency may be any radio frequency (e.g., 30 GHz-300 GHz for mmWave) utilized in the 5G NR technology, or may be 900 MHz, 2100 MHz, or 2.6 GHz utilized in LTE/LTE-A/TD-LTE technology, or another radio frequency, depending on the RAT in use.

The controller 20 may be a general-purpose processor, a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 10 for wireless communication with the service network 120, storing and retrieving data (e.g., program code and/or the guard timer value) to and from the storage device 30, sending a series of frame data (e.g. representing text messages, graphics, images, etc.) to the display device 40, and receiving user inputs or outputting signals via the I/O device 50.

In particular, the controller 20 coordinates the aforementioned operations of the wireless transceiver 10, the storage device 30, the display device 40, and the I/O device 50 to perform the method of the present application.

In another embodiment, the controller 20 may be incorporated into the baseband processing device 11, to serve as a baseband processor.

As will be appreciated by persons skilled in the art, the circuits of the controller 20 will typically include transistors that are configured in such a way as to control the operation of the circuits in accordance with the functions and operations described herein. As will be further appreciated, the specific structure or interconnections of the transistors will typically be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 30 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data (e.g., the guard timer value), instructions, and/or program code of applications, communication protocols, and/or the method of the present application. In one example, the method of the present application may be implemented as part of the communication protocols which may include a SIP signaling protocol, a 4G LTE protocol stack, and a 5G NR protocol stack. A 4G/5G protocol stack generally may include a Non-Access-Stratum (NAS) layer to communicate with an AMF/SMF/MME entity connecting to the core network 122/132, a Radio Resource Control (RRC) layer for high layer configuration and control, a Packet Data Convergence Protocol/Radio Link Control (PDCP/RLC) layer, a Media Access Control (MAC) layer, and a Physical (PHY) layer.

The display device 40 may be a Liquid-Crystal Display (LCD), a Light-Emitting Diode (LED) display, an Organic LED (OLED) display, or an Electronic Paper Display (EPD), etc., for providing a display function. Alternatively, the display device 40 may further include one or more touch sensors disposed thereon or thereunder for sensing touches, contacts, or approximations of objects, such as fingers or styluses.

The I/O device 50 may include one or more buttons, a keyboard, a mouse, a touch pad, a video camera, a microphone, and/or a speaker, etc., to serve as the Man-Machine Interface (MMI) for interaction with users.

It should be understood that the components described in the embodiment of FIG. 2 are for illustrative purposes only and are not intended to limit the scope of the application. For example, a UE may include more components, such as a power supply, and/or a Global Positioning System (GPS) device, wherein the power supply may be a mobile/replaceable battery providing power to all the other components of the UE, and the GPS device may provide the location information of the UE for use by some location-based services or applications. Alternatively, a UE may include fewer components. For example, the UE may not include the display device 40 and/or the I/O device 50.

Regarding configuration of the guard timer, there may include two parameters, such as the value of the guard timer, and a timeout action indicator which instructs the UE to trigger the fallback from 5G to 4G, or to disconnect the call over 5G and redial the call over 4G, or to maintain the call over 5G, when the guard timer expires. In one embodiment, the configuration of the guard timer may be provided by the currently registered network (e.g., a 5G network). In another embodiment, the UE may apply a default configuration for the guard timer when the currently registered network does not provide a configuration of the guard timer.

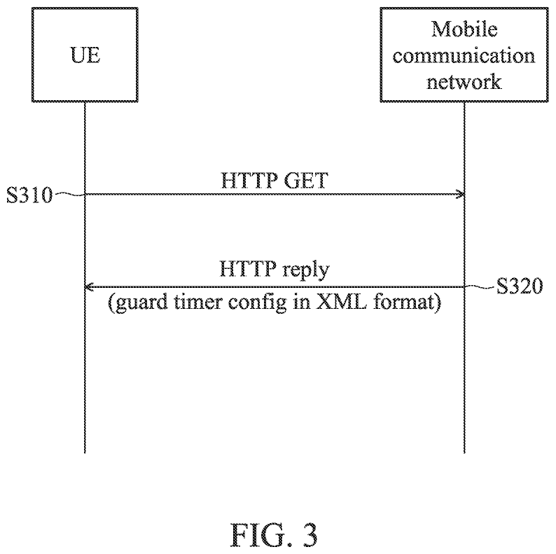

FIG. 3 is a schematic diagram illustrating an example of the guard timer being configurable by network using HyperText Transfer Protocol (HTTP).

In step S310, the UE sends a HTTP GET message to request configuration of the guard timer.

In step S320, the mobile communication network sends a HTTP reply message including the configuration of the guard timer to the UE in response to receiving the HTTP GET message.

In one example, the HTTP reply message may be a 200 OK message, and the configuration of the guard timer may be presented in an eXtensible Markup Language (XML) format in the HTTP reply message.

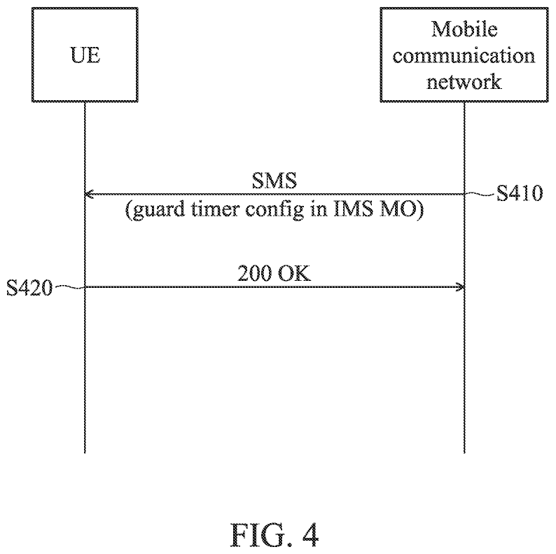

FIG. 4 is a schematic diagram illustrating an example of the guard timer being configurable by network using Short Message Service (SMS).

In step S410, the mobile communication network sends an SMS message including the configuration of the guard timer to the UE. In one example, the configuration of the guard timer may be provided in a node of an IMS Management Object (MO) carried by the SMS message, wherein the node may be a new node dedicated for specifying the configuration of the guard timer.

In step S420, the UE replies to the mobile communication network with a 200 OK message to acknowledge the reception of the SMS message.

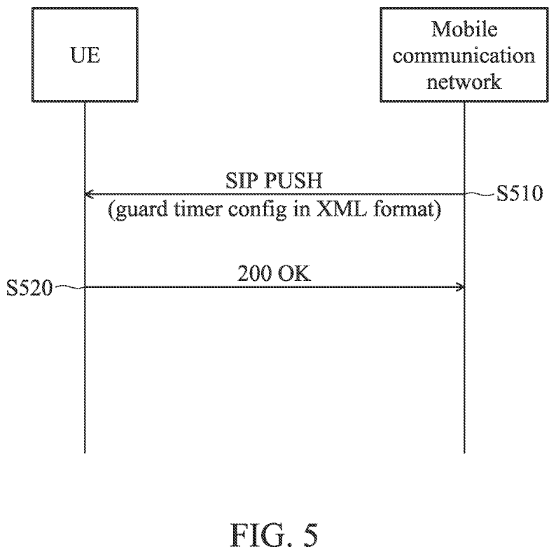

FIG. 5 is a schematic diagram illustrating an example of the guard timer being configurable by network using Session Initiation Protocol (SIP).

In step S510, the mobile communication network sends a SIP PUSH message including the configuration of the guard timer to the UE. In one example, the configuration of the guard timer may be presented in an XML format in the SIP PUSH message.

In step S520, the UE replies to the mobile communication network with a 200 OK message to acknowledge the reception of the SIP PUSH message.

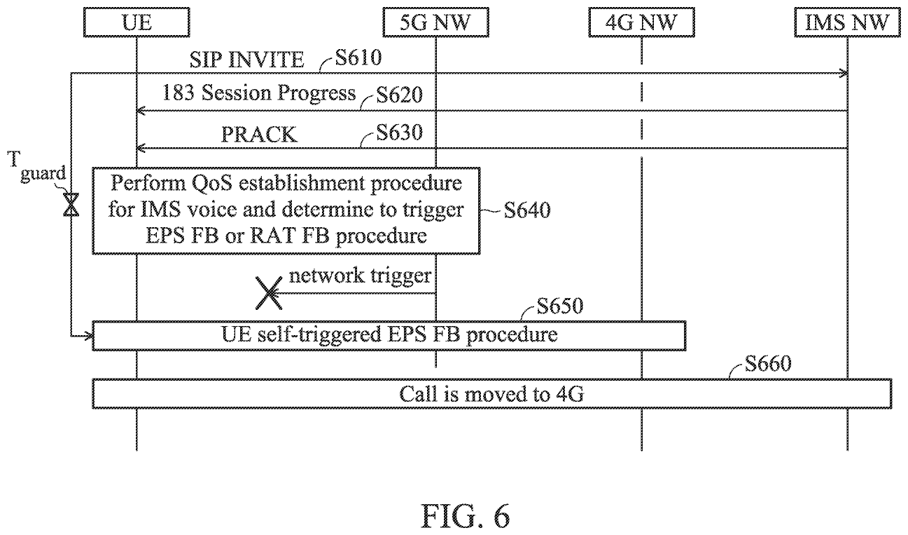

FIG. 6 is a message sequence chart illustrating the enhanced call control using UE-triggered fallback procedure according to an embodiment of the application.

In this embodiment, the UE and the 5G network use the precondition call flow to set up the call. The precondition call flow is a certain flow architecture that requires the participants to reserve network resources before continuing with the session (as defined in the Request for Comments (RFC) 3312).

In step S610, the UE sends an INVITE message with Session Description Protocol (SDP) attributes to initiate an IMS call in the 5G network, and starts a guard timer (denoted as T_{guard} in FIG. 6). Specifically, the SIP session is performed using the Transmission Control Protocol (TCP).

It should be noted that in another embodiment, the guard timer may be started when receiving a 100 trying message, if the SIP session is performed using the User Datagram Protocol (UDP).

In step S620, the UE receives a 183. Session Progress message with SDP attributes from the IMS network via the 5G network. The SDP attributes in the INVITE message and the 183. Session Progress message are used to describe the multimedia content of the session, such as resolution, formats, codecs, encryption, etc., so that both peers can understand each other once the data is transferring. That is, in essence, SDP attributes can be understood as the metadata describing multimedia content of the session.

In step S630, the UE receives a Provisional Response ACKnowledgement (PRACK) message from the IMS network via the 5G network.

In step S640, the 5G network performs QoS establishment procedure for IMS voice and then determines to trigger the EPS fallback or RAT fallback procedure.

However, the network trigger command fails to be delivered to the UE before the guard timer expires (e.g., due to bad signal coverage). In one example, the network trigger command is a MobilityFromNRCommand message.

In step S650, the UE triggers the EPS fallback procedure upon expiry of the guard timer.

Specifically, the UE may determine whether to trigger the EPS fallback procedure or the RAT fallback procedure based on the condition for call continuation in the 5G network. For example, the condition for call continuation in the 5G network may include at least one of: (1) the QoS configuration is allocated by the 5G network; (2) the signal-strength indicator (e.g., Received Signal Strength Indicator (RSSI), Packet Error Rate (PER), Bit Error Rate (BER), Signal-to-Noise Ratio (SNR), or Interference-to-Signal Ratio (ISR), etc.) associated with the 5G network is greater than the first threshold; and (3) the user-experience indicator (e.g., jitter buffer delay, round trip delay, or packet loss rate, etc.) is lower than the second threshold.

To clarify further, in one example, the UE may determine to trigger the EPS fallback procedure if the condition for call continuation in the 5G network is not met and the SIP session for establishing the IMS call is not completed (i.e., ACK is not received). In another example, the UE may determine to trigger the RAT fallback procedure if the condition for call continuation in the 5G network is not met and the SIP session for establishing the IMS call is completed (i.e., ACK is received). Alternatively, for non-precondition flow, the QoS establishment and ACK reception may occur in parallel or independently, and the UE may determine to trigger the RAT fallback procedure in this case.

In step S660, the call is moved to the 4G network (i.e., the call is set up in the 4G network).

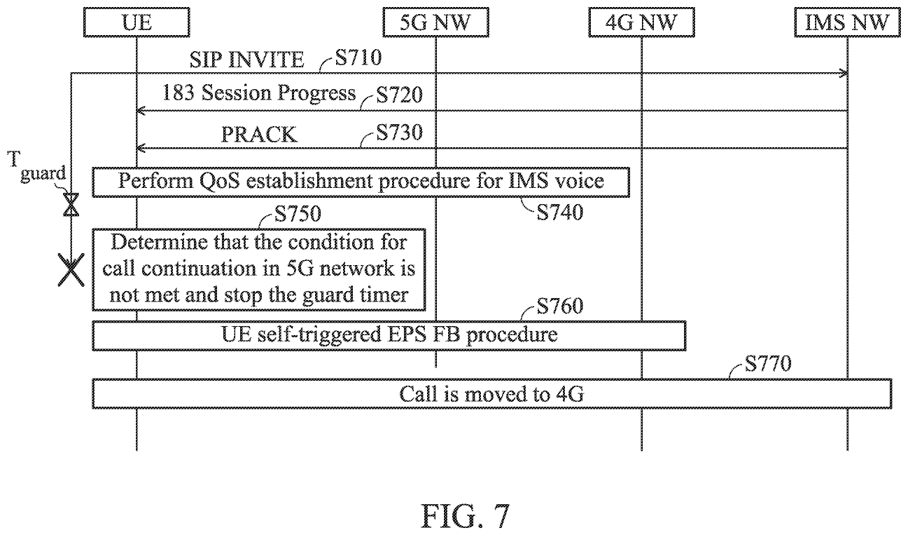

FIG. 7 is a message sequence chart illustrating the enhanced call control using UE-triggered fallback procedure according to another embodiment of the application.

In this embodiment, steps S710˜S740 are the same as steps S610˜S640 in the embodiment of FIG. 6. However, after the QoS establishment procedure is completed, the UE determines that the condition for call continuation in the 5G network is not met (e.g., due to poor network condition of insufficient bandwidth allocated by network) and stops the guard timer (step S750).

Specifically, during the QoS establishment procedure, SIP signaling may be exchanged to negotiate the requested and allocated QoS. For example, the UE may send an UPDATE message including SDP attributes to indicate the requested QoS, and the 5G network may reply a 200 OK message including SDP attributes to indicate the allocated QoS.

Next, the UE triggers the EPS fallback procedure and the call is moved to the 4G network (steps S760˜S770).

Regarding the UE self-triggered EPS fallback procedure, the UE may behave like the case of 5G to EPS without N26 connection as specified in the 3GPP TS 23.502. Specifically, the UE may trigger to start the Tracking Area Update (TAU) procedure in the 4G network and then attach to the 4G network to request a Packet Data Network (PDN) connectivity for the IMS call. Once the PDN connectivity is established, the 5G network may initiate release of the transferred Protocol Data Unit (PDU) session (if any).

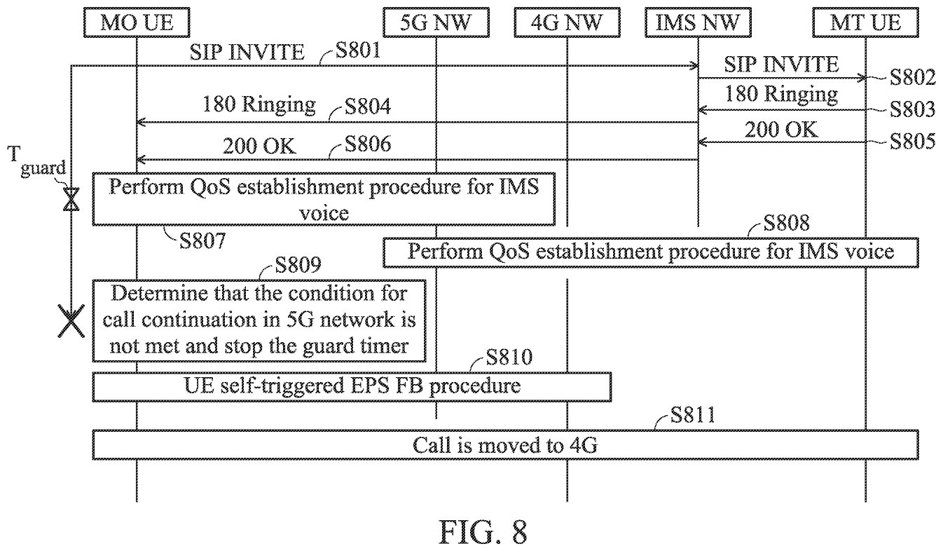

FIG. 8 is a message sequence chart illustrating a Mobile Originated (MO) case of enhanced call control using UE-triggered fallback procedure according to an embodiment of the application.

In this embodiment, the UE and the 5G network use the non-precondition call flow to set up the call. In short, the non-precondition call flow is a flow architecture in contrast to the precondition call flow (i.e., it does not require the participants to reserve network resources before continuing with the session).

In step S801, the caller UE (denoted as MO UE in FIG. 8) sends an INVITE message with SDP attributes to initiate an IMS call in the 5G network, and starts a guard timer (denoted as T_{guard} in FIG. 8). Specifically, the SIP session is performed using TCP.

In step S802, the IMS network forwards the INVITE message to the callee UE (denoted as MT UE in FIG. 8).

In step S803, the callee UE replies to the IMS network with a 180. Ringing message.

In step S804, the IMS network forwards the 180. Ringing message to the caller UE via the 5G network.

In step S805, the callee UE sends a 200 OK message to the IMS network.

In step S806, the IMS network forwards the 200 OK message to the caller UE via the 5G network.

In steps S807˜S808, the 5G network performs QoS establishment procedure for IMS voice and then determines to trigger the EPS fallback or RAT fallback procedure. However, the network trigger command fails to be delivered to the caller UE before the guard timer expires (e.g., due to bad signal coverage).

In step S809, the caller UE determines that the condition for call continuation in the 5G network is not met (e.g., due to poor network condition of insufficient bandwidth allocated by network) and stops the guard timer.

In step S810, the caller UE triggers the EPS fallback procedure due to that the condition for call continuation in the 5G network is not met and the SIP session for establishing the IMS call is not completed (i.e., ACK is not received).

In step S811, the call is moved to the 4G network.

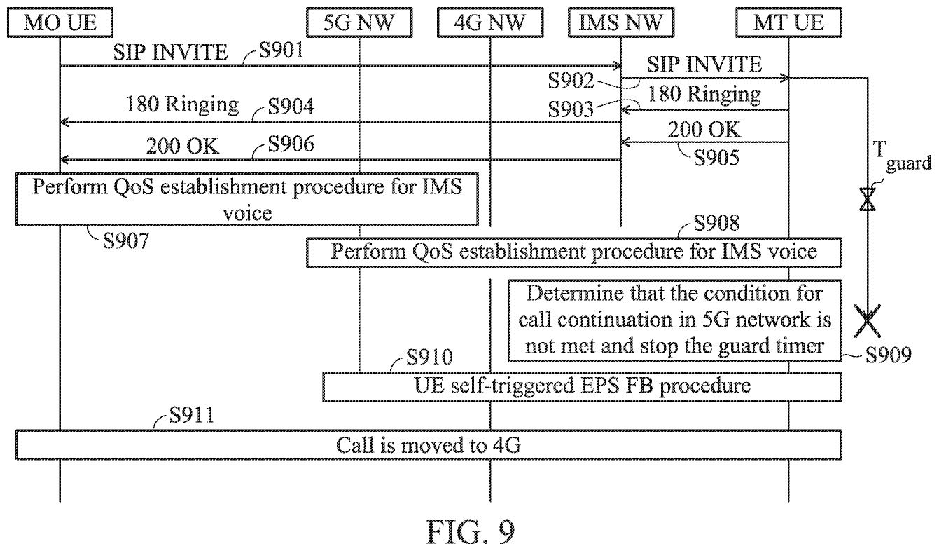

FIG. 9 is a message sequence chart illustrating a Mobile Terminated (MT) case of enhanced call control using UE-triggered fallback procedure according to an embodiment of the application.

In this embodiment, steps S901˜S908 are similar to steps S801˜S808 in the embodiment of FIG. 9, except that the guard timer is started by the callee UE when receiving the INVITE message.

In step S909, the callee UE determines that the condition for call continuation in the 5G network is not met (e.g., due to poor network condition of insufficient bandwidth allocated by network) and stops the guard timer.

In step S910, the callee UE triggers the EPS fallback procedure due to that the condition for call continuation in the 5G network is not met and the SIP session for establishing the IMS call is not completed (i.e., ACK is not received).

In step S911, the call is moved to the 4G network.

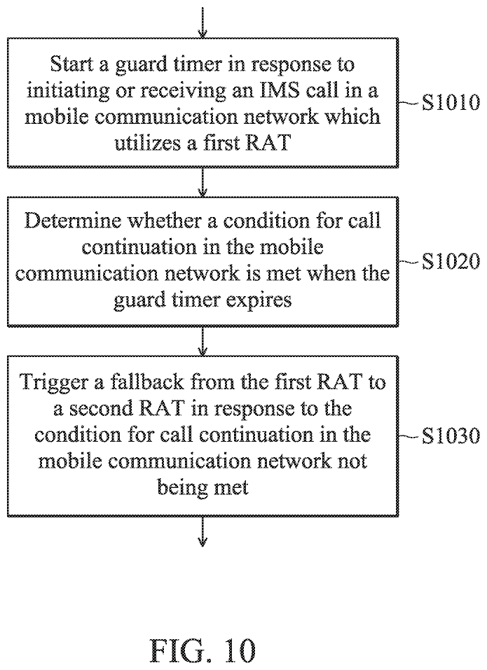

FIG. 10 is a flow chart illustrating the method for enhanced call control using UE-triggered fallback procedure according to an embodiment of the application.

In step S1010, a UE starts a guard timer in response to initiating or receiving an IMS call in a mobile communication network which utilizes a first RAT. In one example, the guard timer is started when sending or receiving an INVITE message during a SIP session using TCP. In another example, the guard timer is started when receiving a 100 trying message during a SIP session using UDP.

In step S1020, the UE determines whether a condition for call continuation in the mobile communication network is met when the guard timer expires. In one example, the condition for call continuation in the mobile communication network may include at least one of: (1) the QoS configuration is allocated by the 5G network; (2) the signal-strength indicator (e.g., RSSI, PER, BER, SNR, ISR, or others) associated with the mobile communication network is greater than the first threshold; and (3) the user-experience indicator (e.g., jitter buffer delay, round trip delay, packet loss rate, or others) is lower than the second threshold.

In step S1030, the UE triggers a fallback from the first RAT (e.g., 5G) to a second RAT (e.g., 4G) in response to the condition for call continuation in the mobile communication network not being met. In one example, the fallback is the EPS fallback if the SIP session for establishing the IMS call is not yet completed. In another example, the fallback is the RAT fallback if the SIP session for establishing the IMS call is completed.

While the application has been described by way of example and in terms of preferred embodiment, it should be understood that the application is not limited thereto. Those who are skilled in this technology can still make various alterations and modifications without departing from the scope and spirit of this application. Therefore, the scope of the present application shall be defined and protected by the following claims and their equivalents.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

What is claimed is:

1. A method, executed by a User Equipment (UE), comprising:
starting a guard timer in response to initiating or receiving an Internet Protocol (IP) Multimedia Subsystem (IMS) call in a mobile communication network which utilizes a first Radio Access Technology (RAT);
determining whether a condition for call continuation in the mobile communication network is met when the guard timer expires; and
triggering a fallback from the first RAT to a second RAT in response to the condition for call continuation in the mobile communication network not being met.

2. The method as claimed in claim 1, further comprising:
receiving Quality of Service (QoS) configuration for the IMS call from the mobile communication network before the guard timer expires; and
stopping the guard timer and triggering the fallback from the first RAT to the second RAT in response to the QoS configuration indicating insufficient resources for call continuation in the mobile communication network.

3. The method as claimed in claim 1, wherein a value of the guard timer is configured by the mobile communication network, or the UE applies a default value for the guard timer.

4. The method as claimed in claim 3, wherein the value of the guard timer is configured by the mobile communication network using a HyperText Transfer Protocol (HTTP), Short Message Service (SMS), or Session Initiation Protocol (SIP).

5. The method as claimed in claim 3, wherein the value of the guard timer is configured in an IMS Management Object (MO) received from the mobile communication network.

6. The method as claimed in claim 5, wherein the IMS MO comprises a node for the guard timer, which specifies the following:
the value of the guard timer; and
a timeout action indicator which instructs the UE to trigger the fallback from the first RAT to the second RAT, or to disconnect the call over the first RAT and redial the call over the second RAT, or to maintain the call over the first RAT, when the guard timer expires.

7. The method as claimed in claim 1, wherein the condition for call continuation in the mobile communication network comprises at least one of:
Quality of Service (QoS) configuration is allocated by the mobile communication network;
a signal-strength indicator associated with the mobile communication network is greater than a first threshold; and
a user-experience indicator is lower than a second threshold.

8. The method as claimed in claim 7, wherein the signal-strength indicator is a Received Signal Strength Indicator (RSSI), a Packet Error Rate (PER), a Bit Error Rate (BER), a Signal-to-Noise Ratio (SNR), or an Interference-to-Signal Ratio (ISR), and the user-experience indicator is a jitter buffer delay, a round trip delay, or a packet loss rate.

9. The method as claimed in claim 1, wherein the guard timer is started when sending or receiving an INVITE message during a SIP session using a Transmission Control Protocol (TCP), or when receiving a 100 trying message during a SIP session using a User Datagram Protocol (UDP).

10. The method as claimed in claim 1, wherein the fallback from the first RAT to the second RAT is an Evolved Packet System (EPS) FallBack (FB) in response to the condition for call continuation in the mobile communication network not being met before a SIP session for establishing the IMS call is completed, or the fallback from the first RAT to the second RAT is a RAT FB in response to the condition for call continuation in the mobile communication network not being met after the SIP session for establishing the IMS call is completed.

11. A User Equipment (UE), comprising:
a wireless transceiver which, during operation, performs wireless transmission and reception using a first Radio Access Technology (RAT) or a second RAT; and
a controller communicatively coupled to the wireless transceiver such that, during operation, the controller performs operations comprising:
starting a guard timer in response to initiating or receiving, via the wireless transceiver, an Internet Protocol (IP) Multimedia Subsystem (IMS) call in a mobile communication network which utilizes the first RAT;
determining whether a condition for call continuation in the mobile communication network is met when the guard timer expires; and
triggering a fallback from the first RAT to the second RAT via the wireless transceiver in response to the condition for call continuation in the mobile communication network not being met.

12. The UE as claimed in claim 11, wherein, during operation, the controller further performs operations comprising:
receiving, via the wireless transceiver, Quality of Service (QoS) configuration for the IMS call from the mobile communication network before the guard timer expires; and
stopping the guard timer and triggering the fallback from the first RAT to the second RAT via the wireless transceiver in response to the QoS configuration indicating insufficient resources for call continuation in the mobile communication network.

13. The UE as claimed in claim 11, wherein a value of the guard timer is configured by the mobile communication network, or the controller applies a default value for the guard timer.

14. The UE as claimed in claim 13, wherein the value of the guard timer is configured by the mobile communication network using a HyperText Transfer Protocol (HTTP), Short Message Service (SMS), or Session Initiation Protocol (SIP).

15. The UE as claimed in claim 13, wherein the value of the guard timer is configured in an IMS Management Object (MO) received from the mobile communication network.

16. The UE as claimed in claim 15, wherein the IMS MO comprises a node for the guard timer, which specifies the following:
the value of the guard timer; and
a timeout action indicator which instructs the UE to trigger the fallback from the first RAT to the second RAT, or to disconnect the call over the first RAT and redial the call over the second RAT, or to maintain the call over the first RAT, when the guard timer expires.

17. The UE as claimed in claim 11, wherein the condition for call continuation in the mobile communication network comprises at least one of:
Quality of Service (QoS) configuration is allocated by the mobile communication network;
a signal-strength indicator associated with the mobile communication network is greater than a first threshold; and
a user-experience indicator is lower than a second threshold.

18. The UE as claimed in claim 17, wherein the signal-strength indicator is a Received Signal Strength Indicator (RSSI), a Packet Error Rate (PER), a Bit Error Rate (BER), a Signal-to-Noise Ratio (SNR), or an Interference-to-Signal Ratio (ISR), and the user-experience indicator is a jitter buffer delay, a round trip delay, or a packet loss rate.

19. The UE as claimed in claim 11, wherein the guard timer is started when sending or receiving an INVITE message during a SIP session using a Transmission Control Protocol (TCP), or when receiving a 100 trying message during a SIP session using a User Datagram Protocol (UDP).

20. The UE as claimed in claim 11, wherein the fallback from the first RAT to the second RAT is an Evolved Packet System (EPS) FallBack (FB) in response to the condition for call continuation in the mobile communication network not being met before a SIP session for establishing the IMS call is completed, or the fallback from the first RAT to the second RAT is a RAT FB in response to the condition for call continuation in the mobile communication network not being met after the SIP session for establishing the IMS call is completed.
